(19) United States
(12) Patent Application Publication
(10) Pub. No.: US 2005/0255339 A1
(43) Pub. Date: Nov. 17, 2005

(54) Metal air cell system

(76) Inventors: Tsepin Tsai, Chappaqua, NY (US); George Tzong-Chyi Tzeng, Elmsford, NY (US); Michael Glover, Pinebush, NY (US); Lin-Feng Li, Croton, NY (US); William F. Morris, Mystic, CT (US)

Correspondence Address: Reveo Inc, 85 Executive Boulevard, Elmsford, NY, 10523, US

(21) Appl. No.: 10/505,112

(22) PCT Filed: Feb. 20, 2003
(86) PCT No.: PCT/US03/05295

§ 371 Date: May 16, 2005

Related U.S. Application Data
(60) Provisional application No. 60/358,229, filed on Feb. 20, 2002.

(51) Int. Cl. H01M 8/00

(52) U.S. Cl. 429/12; 429/40; 429/33; 427/115

(57) ABSTRACT

A Metal air cell and cell system is provided. In general, the cell includes a cathode structure comprising opposing cathode portions and a space configured for receiving an anode structure. The anode structure includes a pair of rigid structures having plural apertures for allowing ionic communication and anode material between the rigid structures. A separator is disposed between the anode and the cathode to electrically isolate the anode and the cathode. The rigid structures of the anode structure facilitate removal of the anode structure from the cathode structure. In certain embodiments, anode structures are formed with bimodal gelling agents to promote an even distribution of anode material and electrolyte gel.

### BACKGROUND OF TH INVENTION

1. Field of the Invention

The present application claims priority to U.S. Provisional Patent Application Ser. No. 60/312,516 filed on Aug. 15, 2001 entitled “Metal Air Cell System”. This invention relates to metal air cells, and particularly to a metal air cell system having a novel configuration promoting efficient cell discharge and simplified oxidant management.

2. Description of the Prior Art

Electrochemical power sources are devices through which electric energy can be produced by means of electrochemical reactions. These devices include metal air electrochemical cells such as zinc air and aluminum air batteries. Certain metal electrochemical cells employ an anode comprised of metal particles that are fed into the cell and consumed during discharge. Such electrochemical cells are often called refuelable batteries. Zinc air refuelable battery cells include an anode, a cathode, and an electrolyte. The anode is generally formed of zinc particles immersed in electrolyte. The cathode generally comprises a semipermeable membrane and a catalyzed layer for electrochemical reaction. The electrolyte is usually a caustic liquid that is ionic conducting but not electrically conducting.

Metal air electrochemical cells have numerous advantages over traditional hydrogen-based fuel cells. Metal air electrochemical cells have high energy density (W*hr/Liter), high specific energy (W*hr/kg), and run at ambient temperature. Further, the supply of energy provided from metal air electrochemical cells is virtually inexhaustible because the fuel, such as zinc, is plentiful and can exist either as the metal or its oxide. The fuel may be solid state, therefore, safe and easy to handle and store. In contrast to a hydrogen-oxygen fuel cell, which uses methane, natural gas, or liquefied natural gas to provide as source of hydrogen, and emit polluting gases, the metal air electrochemical cells results in zero emission.

The metal air electrochemical cells operate at ambient temperature, whereas hydrogen-oxygen fuel cells typically operate at temperatures in the range of 150° C. to 1000° C. Metal air electrochemical cells are capable of delivering higher output voltages (1.5-3 Volts) than conventional fuel cells (<0.8V). Due to these advantages, metal air electrochemical cells can be used as power sources of all kind of applications, like stationary or mobile power plant, electric vehicle or portable electronic device, etc.

One of the principle obstacles of metal air electrochemical cells is the inherent volume expansion of the metal, wherein the electrode shape may vary. Electrode shape change generally involves migration of zinc from the certain regions of the electrode to other reasons, and occurs, in part, as the active electrode material dissolves away during battery discharge. Swelling and deformity of zinc electrodes also occur due to the differences in volume of metallic zinc and its oxidation products zinc oxide and zinc hydroxide. Electrode shape distorts as the zinc is redeposited in a dense solid layer, thereby minimizing available active electrode material and preventing electrolyte access to the electrode interior.

Yet another obstacle relates to refueling of metal air cells. If the clearance between the anode and cathode is not large enough to accommodate the anode expansion, the cathode may be damaged and hence render refueling difficult or impossible. The distance between anode and cathode should be constant. If the distance between the anode and cathode is not constant, the discharging between the anode and cathode will be uneven. This uneven discharging will cause the anode to bend or deform. This bend on the anode is caused by the volume change due to the metal oxidation. When the anode is bent, the anode area, which is closer to the cathode, discharges faster than the rest of the anode. This will increase the deformation. Therefore, the uneven discharging is magnified, and the problem continues until the bending causes cell failure, for example by shorting with the anode. Also, the uneven discharging will reduce the power output of the cell. If the cell is discharged at very high power, the regions of the anode closer to cathode will be passivated and lose functionality.

In order to refuel, the anode and cathode should have certain distance between them to provide the clearance for the refueling action. Conventionally, this clearance is filled with electrolyte and separator. However, this clearance will increase the cell internal resistance. This internal resistance will generate heat during use, which may cause various detriments. The heat consumes power from the cell, will dry out the electrolyte quickly, and speeds up the deterioration of the fuel cell. In order to reduce the internal resistance, the distance between the anode and cathode should be small and even. Nonetheless, this conventionally sacrifices durability. During the refueling process, if the distance between anode and cathode is not sufficient, the anode may scrape the cathode surface. Excess clearance, while reducing the likelihood of cathode damage during the refueling, increases the internal resistance. Therefore, conventional provision of sufficient clearance between the anode and cathode results in increased internal resistance between them.

Therefore, a need remains in the art for a metal air cell that is refuelable, does not leak, minimizes anode degradation due to clearance between the anode and the cathode, and includes an efficient system for oxygen and thermal management.

### SUMMARY OF THE INVENTION

The above discussed and other problems and deficiencies of the prior art are overcome or alleviated by the metal air cell of the present invention. In general, the cell includes a cathode structure comprising opposing cathode portions and a space configured for receiving an anode structure. The anode structure includes a pair of rigid structures having plural apertures for allowing ionic communication and anode material between the rigid structures. A separator is disposed between the anode and cathode to electrically isolate the anode and the cathode. The rigid structures of the anode structure facilitate removal of the anode structure from the cathode structure.

The above discussed and other features and advantages of the present invention will be appreciated and understood by those skilled in the art from the following detailed description and drawings.

### BRIEF DESCRIPTION OF THE DRAWINGS

FIGS. 1 and 2 show a metal air electrochemical cell system of the present invention;

FIGS. 3A-6D show anode structures and methods of manufacture of anode structures;

FIGS. 7A-11 show cathode structures and methods of manufacture of cathode structures; and

FIGS. 12A and 12B show enlarged views of the interface between the electrode structures.

### DETAILED DESCRIPTION OF THE ILLUSTRATIVE EMBODIMENTS

A metal air cell includes an anode and the cathode having a readily removable anode structure. Features of the anode structure, cathode structure, gel formulations, and other aspects of the metal air cell system are described herein.

Referring now to the drawings, an illustrative embodiment of the present invention will be described. For clarity of the description, like features shown in the figures shall be indicated with like reference numerals and similar features as shown in alternative embodiments shall be indicated with similar reference numerals.

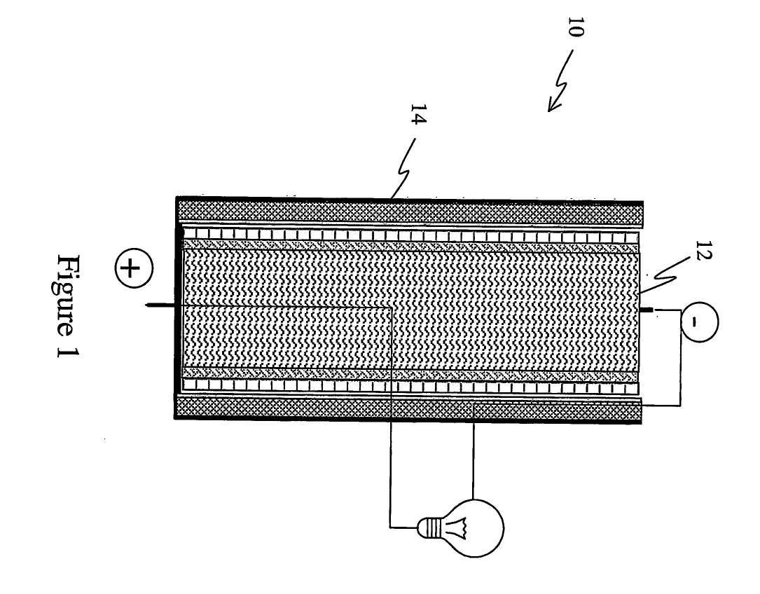

Referring now to FIG. 1, a metal air electrochemical cell 10 of a generally prismatic configuration is depicted. The cell 10 includes an anode structure 12 within an essentially U-shaped cathode structure 14. The anode 12 and the cathode 14 are maintained in electrical isolation and ionic communication through a separator, described further herein.

Oxygen from the air or another source is used as the reactant for the air cathode of the metal air cell 10. When oxygen reaches the reaction sites within the cathode structure 14, it is converted into hydroxyl ions together with water. At the same time, electrons are released to flow as electricity in the external circuit. The hydroxyl travels through electrolyte to reach the metal fuel material of the anode 12. When hydroxyl reaches the metal anode (in the case of an anode 12 comprising, for example, zinc), zinc hydroxide is formed on the surface of the zinc. Zinc hydroxide decomposes to zinc oxide and releases water back to the alkaline solution. The reaction is thus completed.

The anode reaction is:
Zn+4OH⁻→Zn(OH)₄²⁻+2e (1)
Zn(OH)₄²⁻→ZnO+H₂O+2OH⁻ (2)

The cathode reaction is:
½O₂+H₂O+2e→2OH⁻ (3)

Thus, the overall cell reaction is:
Zn+½O₂→ZnO (4)

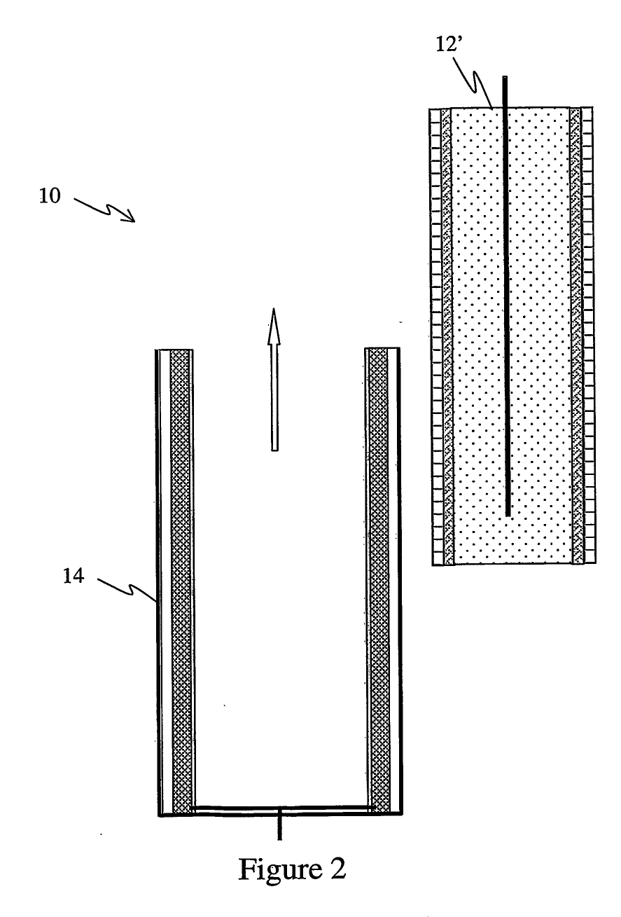

Referring now to FIG. 2, removal of an anode 12′, which has had essentially all of the consumable fuel therein converted to a metal oxide as generally described above in reactions (1) through (4), is shown. In one embodiment, due to the features of the anode 12 described herein, removal of the spent anode 12′ is substantially facilitated as compared to conventional anode configurations and constructions. In another embodiment, due to the features of the cathode 14 described herein, removal of the spent anode 12′ is substantially facilitated as compared to conventional cathode configurations and constructions. In still another embodiment, due to the features of a convenient interfacial gel described herein between the cathode 14 and the anode 12, removal of the spent anode 12′ is substantially facilitated as compared to conventional interfacial gel formulations.

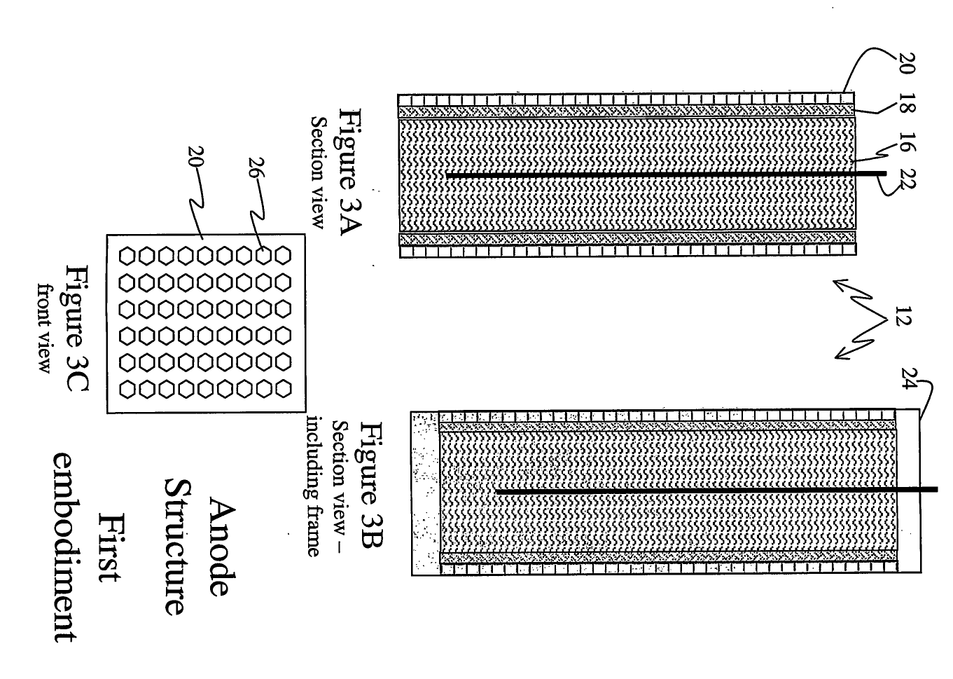

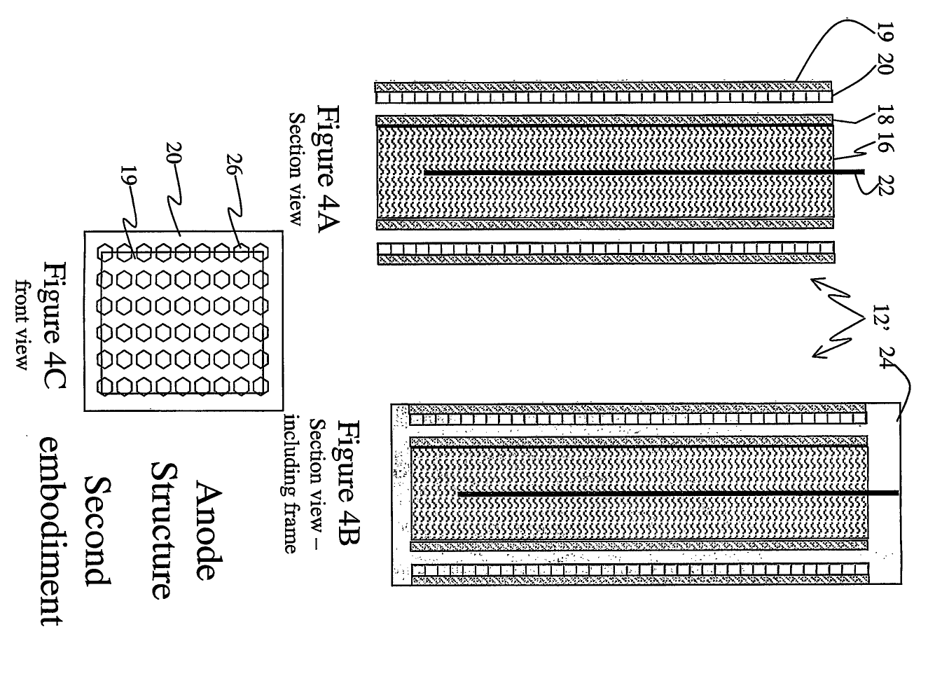

Referring now to FIGS. 3A-3C, the anode structure 12 is schematically depicted. The anode structure 12 includes a consumable anode portion 16 surrounded on its two opposing major faces with a separator 18 and a rigid structure 20, a current collector 22 and a frame 24. The separator 18 may be disposed on the rigid structures 20, on the anode portion 16, or both. For example, referring now to FIGS. 4A-4C, an anode structure 12′ is schematically depicted, including the components of anode 12 (FIGS. 3A-3C) and a separator 19 on the outside surface of the rigid structure 20.

In particular, the use of the rigid structures 20, which contain plural apertures 26, maintains structural integrity of the anode structure 12, thereby facilitating removal when the consumable anode material 16 is spent, despite the tendency of the anode material 16 to expand during conversion (reactions (1) through (4)). The structures 20 are non-conductive conductive. They may be formed of materials including, but not limited to, plastic, plastic coated metal, ceramics, non-conductive or coated carbon composites, and combinations comprising at least one of the foregoing materials. The plural apertures may be of any shape or size, so long as the requisite structural integrity is maintained. For example, although the apertures 26 are shown in the form of hexagons, any polygon, circle, ellipse, slot-shaped, or other shape may be used. The open area is generally sufficient to allow reaction between the anode material 16 and the active cathode area, which may vary depending on performance needs. In one embodiment, plastic coated steel honeycomb mesh having an open area ratio of about 78% and a thickness of about 0.8 millimeters is used. Of course, these characteristics may vary depending on factors such as the performance demands, overall size of the cell, intended environment of the cell, and desired ease of refuelability.

Optionally, the rigid structures 20 may be attached to each other. For example, structures 20 may be formed with snap-fit portions, that further enhance the structural integrity when the anode tends to expand.

The consumable anode portion 16 may be pressed, sintered, or otherwise formed into the desired shape (e.g., prismatic as shown in the figures). In one embodiment, an electrolyte comprises a solid, liquid, or combination thereof that is in ionic communication with the active cathode portions and the consumable anode portion 16. In an alternative embodiment, at least a portion of the electrolyte used in the cell is embedded into the porous structure of the consumable anode portion 16, as described herein. The separator 18 is therefore disposed between the anode and cathode for electrical isolation. The separator 18 is shown as disposed the surface of the anode; however, the separator may alternatively be disposed on only the cathode (e.g., wherein the consumable anode portion 16 is formed as to minimize migration through the rigid structure 20), or both the anode and cathode.

Anode portion 16 generally comprises a metal constituent such as metal and/or metal oxides and the current collector 22. Optionally an ionic conducting medium is provided within each anode portion 16. Further, in certain embodiments, anode portion 16 comprises a binder and/or suitable additives. Preferably, the formulation optimizes ion conduction rate, capacity, density, and overall depth of discharge, while minimizing shape change during cycling.

The metal constituent may comprise mainly metals and metal compounds such as zinc, calcium, lithium, magnesium, ferrous metals, aluminum, oxides of at least one of the foregoing metals, or combinations and alloys comprising at least one of the foregoing metals. These metals may also be mixed or alloyed with constituents including, but not limited to, bismuth, calcium, magnesium, aluminum, indium, lead, mercury, gallium, tin, cadmium, germanium, antimony, selenium, thallium, oxides of at least one of the foregoing metals, or combinations comprising at least one of the foregoing constituents.

The metal constituent may be provided in the form of powder, fibers, dust, granules, flakes, needles, pellets, or other particles. In certain preferred embodiments, fibrous metal, particularly zinc fiber material, is provided as the metal constituent. During conversion in the electrochemical process, the metal is generally converted to a metal oxide. In preferred embodiments where the metal is in fiber form, the porosity or void volume of the mass of anode material is maximized as compared to granule zinc; accordingly, detriments typically associated with the inherent anode expansion during conversion are minimized, as expanded zinc oxide may be accumulated in the void regions.

The anode current collector 22 may be any electrically conductive material capable of providing electrical conductivity. The current collector may be formed of various electrically conductive materials including, but not limited to, copper, brass, ferrous metals such as stainless steel, nickel, carbon, electrically conducting polymer, electrically conducting ceramic, other electrically conducting materials that are stable in alkaline environments and do not corrode the electrode, or combinations and alloys comprising at least one of the foregoing materials. The current collector may be in the form of a mesh, porous plate, metal foam, strip, wire, plate, or other suitable structure. To facilitate connection of plural cells 10, anode current collectors 22 may be conductively attached (e.g., welded, riveted, bolted, or a combination thereof) to a common bus, connecting the cells in series, parallel, or combination series/parallel, as is conventionally known.

The optional binder of the anode primarily maintains the constituents of the anode in a solid or substantially solid form in certain configurations. The binder may be any material that generally adheres the anode material and the current collector to form a suitable structure, and is generally provided in an amount suitable for adhesive purposes of the anode. This material is preferably chemically inert to the electrochemical environment. In certain embodiments, the binder material is soluble, or can form an emulsion, in water, and is not soluble in an electrolyte solution. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

Optional additives may be provided to prevent corrosion. Suitable additives include, but are not limited to indium oxide; zinc oxide, EDTA, surfactants such as sodium stearate, potassium Lauryl sulfate, Triton® X400 (available from Union Carbide Chemical & Plastics Technology Corp., Danbury, Conn.), and other surfactants; the like; and derivatives, combinations and mixtures comprising at least one of the foregoing additive materials. In one embodiment, a suitable additive is described in PCT Application Number PCT/US02/19282 entitled “Zinc Anode for Electrochemical Cell” filed Jun. 17, 2002 and incorporated by reference herein. However, one of skill in the art will determine that other additive materials may be used.

An electrolyte or ionic conducting medium is also provided in the cell 10, generally comprising alkaline media to provide a path for hydroxyl to reach the metal and metal compounds. The ionically conducting medium may be in the form of a bath, wherein a liquid electrolyte solution is suitably contained. In certain embodiments, an ion conducting amount of electrolyte is provided in anode 28. The electrolyte generally comprises ionic conducting materials such as KOH, NaOH, LiOH, other materials, or a combination comprising at least one of the foregoing electrolyte media. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 45% ionic conducting materials. Other electrolytes may instead be used, however, depending on the capabilities thereof, as will be obvious to those of skill in the art.

To provide a cell that minimizes or obviates the need for a liquid electrolyte material, the anode portion 16 may include an ionic conductive quantity of electrolyte gel incorporated and cured therein. This may be accomplished during original shaping of the anode portions 16 (e.g., or at a later stage of processing). For example, processing of electrodes is described in further detail in U.S. patent application Ser. No. 10/074,873 entitled “Anode Structure For Metal Air Electrochemical Cells And Method Of Manufacture Thereof,” filed on Feb. 11, 2002, which is incorporated by reference herein. Processing of fibrous electrodes is described in more detail in U.S. patent application Ser. No. 10/083,717 entitled “Fibrous Electrode For a Metal Air Electrochemical Cell” which is incorporated by reference herein.

Thus, an electrolyte liquid is mixed with a gelling agent to provide a metal-electrolyte mixture. This mixture may be cured, for example, to a rubbery state having metal material dispersed therein (which is more predominant when the metal is in fibrous form).

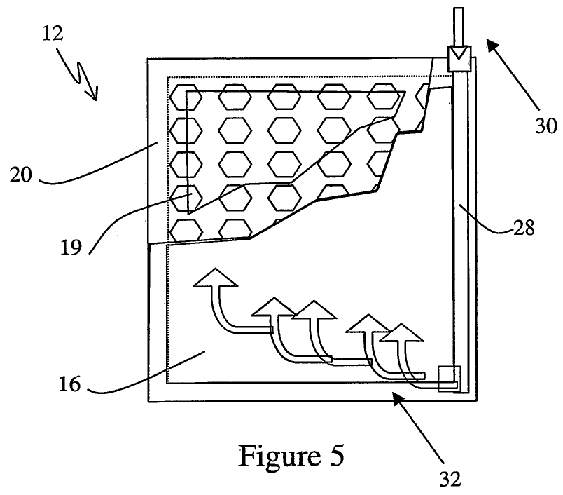

Referring now to FIG. 5, an anode structure 12 includes a tube 28 having an inlet and an outlet, wherein a gelling agent formulation (in an uncured state) is injected (as indicated by arrow 30) and spreads throughout the cell (as indicated by arrows 32). Using the bimodal gelling formulations described further herein, for example, even distribution of the gel may be attained. Alternatively, the structure may be formed using a single type gelling agent of optimized concentration and material selections, as well as processing techniques (e.g., injecting rapidly after introduction of the gelling agent(s) to the electrolyte solution). In certain embodiments, as depicted in FIG. 5, the anode structure 12 may be filled with electrolyte media in the region of the anode material 16 and further between the separators 18 and 19 (i.e., generally between the separators 18 and 19 and within the apertures 26 of the rigid structure 20).

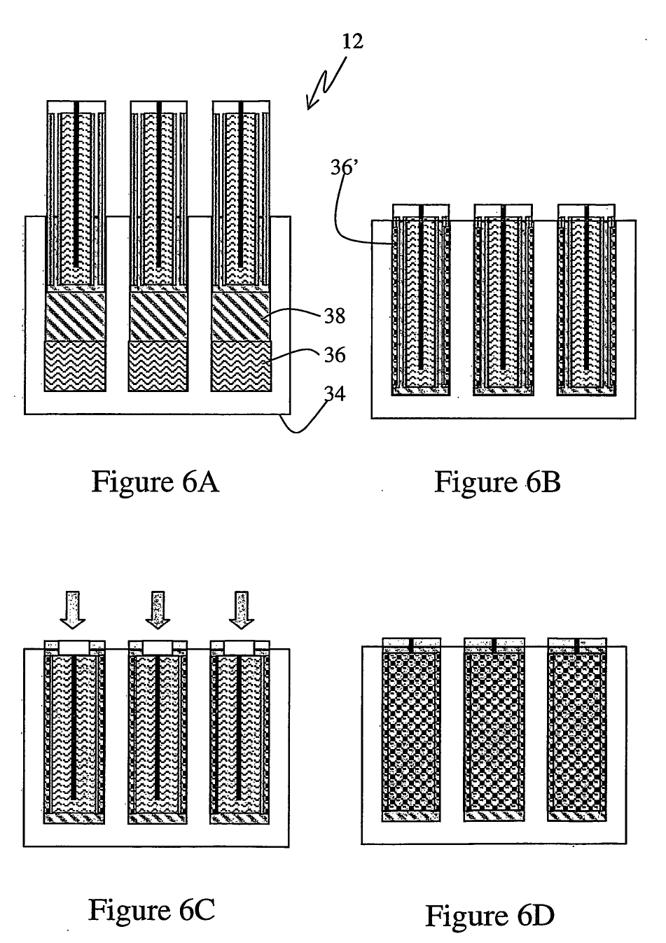

Referring now to FIGS. 6A-6D, another processing technique for forming an anode structure 12 having electrolyte media incorporated therein. A mold 34 is provided to hold one or more anode structures. A quantity of electrolyte media 36 is dispersed in cavities 38 of the mold 34. The electrolyte media 36 may be provided within gelling agents; for example, gelling agents may be incorporated in the anode portion 16, or separately introduced into the system. Alternatively, the electrolyte media 36 may include gelling agents, either a bimodal type as described herein or a conventional type of gelling agent with processing conditions adjusted (e.g., speed) to allow for suitable distribution of the media 36 throughout the anode structure.

In particular, and referring to FIG. 6B, when the anode structure 12 is inserted in the cavity 38, the electrolyte media 36 disperses generally outside of the anode material 16 (e.g., when separator 18 envelopes at least the bottom portion, as oriented in the figures, of the anode material 16). In particular, electrolyte media 36′ disperses between the separators 18 and 19 (i.e., generally between the separators 18 and 19 and within the apertures 26 of the rigid structure 20). Of course, the anode structure 12 may be configured and assembled such that insertion of the anode structure 12 in to the media 36 filled cavity 38 results in electrolyte media permeating throughout the anode structure 12 (e.g., depicted in FIG. 6D).

Referring now to FIG. 6C, if necessary, electrolyte media may be introduced (e.g., injected) via apertures in the frame (before or after the step in FIG. 6B) to allow electrolyte media to permeate through the anode material 16 (shown in FIG. 6D).

It should be noted that one or more gaps or open spaces may remain in the anode structure 12 prior to incorporation of electrolyte media. Such gaps, for example shown in FIG. 4A between rigid structure 20 and separator 18, are suitably dimensioned to accommodate for anode expansion and to provide volume for occupancy be electrolyte media. Further, an open area may be provided at one or both distal ends of the anode structure 12, for example, to allow expansion in the up and down direction (as oriented in the figures) as opposed to sideways, which would detriment the ease of refuelability and could damage the cathode structure 14.

In one embodiment, the formulation of electrolyte and gelling agent comprises a “bimodal” gelling agent electrolyte solution, including a first type gelling agent and a second type gelling agent. The first type gelling agent serves to provide a matrix having a low viscosity (e.g., similar to 45% KOH solution), yet with a sufficient matrix structure to allow dispersion of the second type of gelling agent, which contributes substantially to the desired viscosity of the gelled solution. This prevents the second type of gelling agent from settling, or forming undesirable dense chunks or globs, during gelling.

The first type gelling agent may be selected from the group of gelling agents selected from cellulose fiber (long, medium, short), alpha-fiber, microcrystalline cellulose, and combinations comprising at least one of the foregoing, all commercially available from Aldrich Chemical Co., Inc., Milwaukee, Wis.

The second type gelling agent may be a variety of other gelling agents that provide the desired structural shape to the anode portion 16. The gelling agent may be a crosslinked polyacrylic acid (PAA), such as the Carbopol® family of crosslinked polyacrylic acids (e.g., Carbopol® 675) available from BF Goodrich Company, Charlotte, N.C., Alcosorb® G1 commercially available from Allied Colloids Limited (West Yorkshire, GB), and potassium and sodium salts of polyacrylic acid; carboxymethyl cellulose (CMC), such as those available from Aldrich Chemical Co., Inc., Milwaukee, Wis.; hydroxypropylmethyl cellulose; gelatine; polyvinyl alcohol (PVA); poly(ethylene oxide) (PEO); polybutylvinyl alcohol (PBVA); combinations comprising at least one of the foregoing second type gelling agents; and the like. With a properly selected second type, the time and rate of gelling may be optimized.

A general formulation for the electrolyte media for incorporation within the anode structure 12 is generally as follows. The first type gelling agent concentration (in the base solution without metal) is from about 0.1% to about 50%, preferably about 2% to about 10%, more preferably about 2.5% to about 6.5%. Further, the second type gelling agent concentration (in the base solution without metal) is from about 0.1% to about 50%, preferably about 2% to about 10%, more preferably about 2.5% to about 4.5%. In one particular embodiment, the electrolyte media includes 3% microcystillane (as a first type gelling agent); and 1% CMC 250K and medium viscosity CMC (commercially available from Spectrum) (both as second type gelling agents).

As an alternative to using cards or other substantially solid structures as the anode portion 16, an anode paste may be employed. The anode paste generally comprises a metal constituent and an ionic conducting medium. In certain embodiments, the ionic conducting medium comprises an electrolyte, such as an aqueous electrolyte, and a gelling agent. Preferably, the formulation optimizes ion conduction rate, density, and overall depth of discharge, while being stable (e.g., minimizes or eliminates settling during storage and/or operation), mobile, and pumpable. In certain embodiments, the paste has a viscosity of about 0.1 Pa·s to about 50,000 Pa·s, preferably about 10 Pa·s to about 20,000 Pa·s, and more preferably about 100 Pa·s to about 2,000 Pa·s.

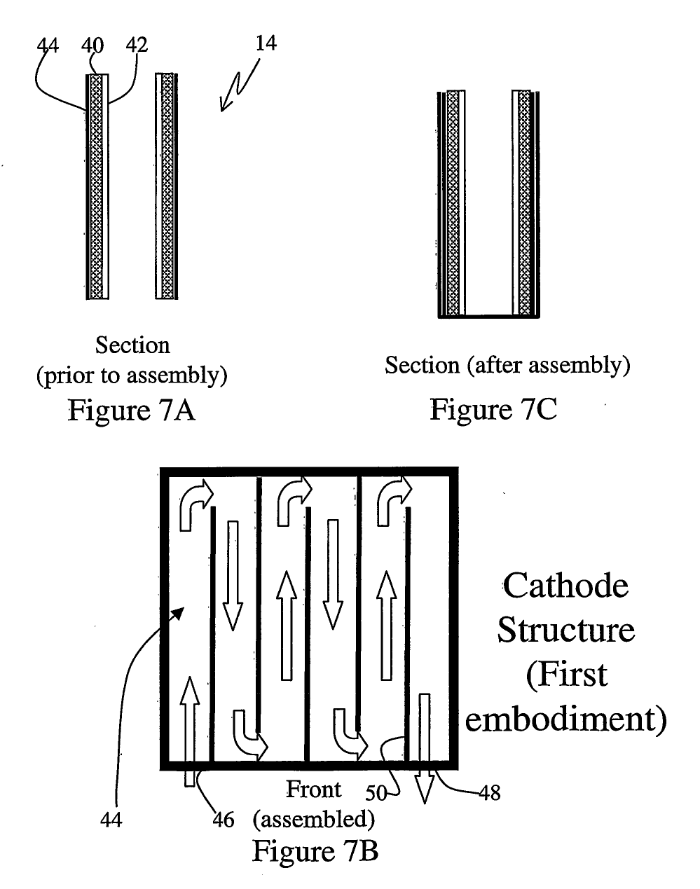

Referring now to FIGS. 7A-7D, an embodiment of a cathode structure 14 is depicted. The cathode structure 14 includes an active cathode portion 40 and an optional separator 42 adjacent thereto (facing toward the center of the cathode structure 14). Note that the separator may be obviated depending on the chosen electrolyte scheme and anode structure. Further, the cathode structure 14 includes air frames 44 positioned adjacent the active cathode portion 40 for assisting in distributed air flow across the surface of the cathode portion 40. Additionally, and referring to FIG. 7B, air enters generally via an inlet 46 of the air frame 44 and exits via an outlet 48, traversing in generally a serpentine manner across the face of the cathode portion 14 due to the barriers 50. An individual cell may be assembled (FIG. 7C), for example, by assembling or pour casting a non-conductive frame structure 52 about the cell components. A current collector may also be formed, an example of which is described further herein.

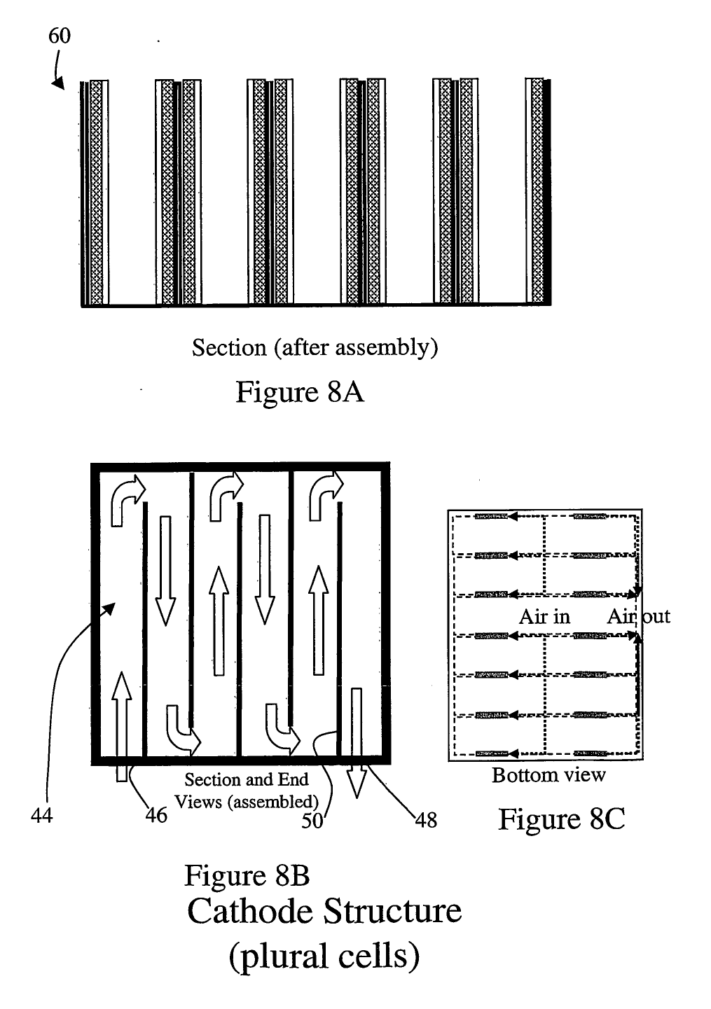

Referring now to FIGS. 8A-8C, an assembly 60 of plural cathode structures 12 is depicted. Inlets and outlets of cathode air frames of adjacent cathode structures 14 are aligned (FIG. 8C), and the barriers 50 of the adjacent air frames preferably form a common serpentine air distribution system (FIG. 8B) across adjacent cathode portions. The entire assembly 60 may be secured together by pour casting, fasteners, frame components, injection molding, or other assembly techniques. In a preferred embodiment, pour casting is used, for example, with appropriate spacers to allow openings for the air channel and for the anode region between adjacent cathode portions of the same cell structure 14.

Other assemblies including plural cells and air management schemes including features that may be useful herein are described in U.S. patent application Ser. Nos. 10/198,397 entitled “Metal Air Cell Incorporating Air Flow System” filed on Jul. 18, 2002, and PCT Application Number PCT/US02/30585 entitled “Rechargeable and Refuelable Metal Air Electrochemical Cell” filed on Sep. 26, 2002, both of which are incorporated herein by reference.

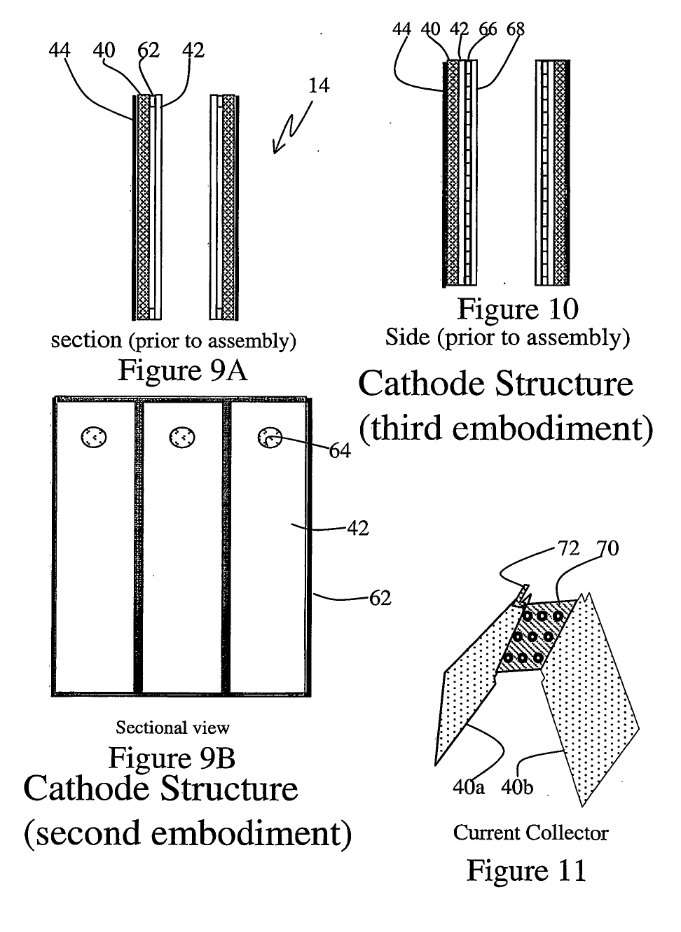

Referring now to FIGS. 9A and 9B, another exemplary cathode structure 14 is depicted. The structure is similar to that depicted in FIGS. 7A-7C, further including a spacer frame 62. Further, the separator 42 includes apertures 64. These apertures (or alternatively flaps) are provided to facilitate incorporation of electrolyte into the cathode structure. Electrolyte media, such as described above with respect to the anode, may be employed generally to increase ionic conductivity of the cell system. In the case of a gel material, this material may e injected via the apertures 64, or otherwise applied in the region created by the spacer 62 between the active cathode 40 and the separator 42.

Generally, where a bimodal gel media is selected as described above, the first type gelling agent concentration (in the base solution without metal) is from about 0.1% to about 50%, preferably about 2% to about 10%, more preferably about 1.5% to about 6%. Further, the second type gelling agent concentration (in the base solution without metal) is from about 0.1% to about 50%, preferably about 2% to about 10%, more preferably about 2.5% to about 8%. In one example, the first type gelling agent is 2% cellulose long fiber, and the second type gelling agent is 4% medium viscosity CMC from Spectrum.

The cathode portions 40 generally include an active constituent and a diluent, along with suitable connecting structures, such as a current collector. The cathode portions 40 may optionally comprise a protective layer (e.g., polytetrafluoroethylene commercially available under the trade name Teflon® from E.I. du Pont Nemours and Company Corp., Wilmington, Del.). Generally, the cathode catalyst is selected to attain current densities (in ambient air) of at least 20 milliamperes per squared centimeter (mA/cm²), preferably at least 50 mA/cm², and more preferably at least 100 mA/cm². Higher current densities may be attained with suitable cathode catalysts and formulations and with use of higher oxygen concentrations, such as substantially pure air.

The oxygen supplied to the cathode portions 40 may be from any oxygen source, such as air; scrubbed air; pure or substantially oxygen, such as from a utility or system supply or from on site oxygen manufacture; any other processed air; or any combination comprising at least one of the foregoing oxygen sources.

Cathode portions 40 may be conventional air diffusion cathodes, for example generally comprising an active constituent and a carbon substrate, along with suitable connecting structures, such as a current collector. Typically, the cathode catalyst is selected to attain current densities in ambient air of at least 20 milliamperes per squared centimeter (mA/cm2), preferably at least 50 mA/cm2, and more preferably at least 100 mA/cm2. Of course, higher current densities may be attained with suitable cathode catalysts and formulations. The cathode may be a bi-functional, for example, which is capable of both operating during discharging and recharging.

The carbon used is preferably be chemically inert to the electrochemical cell environment and may be provided in various forms including, but not limited to, carbon flake, graphite, other high surface area carbon materials, or combinations comprising at least one of the foregoing carbon forms.

The cathode current collector may be any electrically conductive material capable of providing electrical conductivity and preferably chemically stable in alkaline solutions, which optionally is capable of providing support to the cathode portions 10. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal.

A binder is also typically used in the cathode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode. The catalyst material is generally provided in an effective amount to facilitate oxygen reaction at the cathode. Suitable catalyst materials include, but are not limited to: manganese, lanthanum, strontium, cobalt, platinum, and combinations and oxides comprising at least one of the foregoing catalyst materials.

An exemplary air cathode is disclosed in copending, commonly assigned U.S. Pat. No. 6,368,751 entitled “Electrochemical Electrode for Fuel Cell,” Wayne Yao and Tsepin Tsai, issued Apr. 9, 2002, which is incorporated herein by reference in its entirety. Other air cathodes may instead be used, however, depending on the performance capabilities thereof, as will be obvious to those of skill in the art.

To electrically isolate the anode from the cathode, separators are provided at various positions in embodiments of the cell 10 provided herein, generally to electrical isolate but allow ionic communication between the anode and cathode. The separator may be any commercially available separator capable of electrically isolating the anode and the cathode, while allowing sufficient ionic transport therebetween. Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator may also comprise additives and/or coatings such as acrylic compounds and the like to make them more wettable and permeable to the electrolyte.

In certain embodiments, the separator comprises a membrane having electrolyte, such as hydroxide conducting electrolytes, incorporated therein. The membrane may have hydroxide conducing properties by virtue of: physical characteristics (e.g., porosity) capable of supporting a hydroxide source, such as a gelatinous alkaline material; molecular structure that supports a hydroxide source, such as an aqueous electrolyte; anion exchange properties, such as anion exchange membranes; or a combination of one or more of these characteristics capable of providing the hydroxide source.

For instance, the separator may comprise a material having physical characteristics (e.g., porosity) capable of supporting a hydroxide source, such as a gelatinous alkaline solution. For example, various separators capable of providing ionically conducting media are described in: U.S. Pat. No. 5,250,370 entitled “Variable Area Dynamic Battery,” Sadeg M. Faris, Issued Oct. 5, 1993; U.S. Pat. No. 6,296,960 entitled “System and Method for Producing Electrical Power Using Metal Air Fuel Cell Battery Technology,” Sadeg M. Faris, Yuen-Ming Chang, Tsepin Tsai, and Wayne Yao, Issued Oct. 2, 2001; U.S. Pat. No. 6,472,093 entitled “Metal-Air Fuel Cell Battery Systems Having A Metal-Fuel Card Storage Cartridge, Insertable Within A Fuel Cartridge Insertion Port, Containing A Supply Of Substantially Planar Discrete Metal-Fuel Cards, And Fuel Card Transport Mechanisms Therein,” Sadeg M. Faris, Tsepin Tsai, Issued Oct. 10, 2002; U.S. Pat. No. 6,299,997 entitled “Ionically-Conductive Belt Structure for Use in a Metal-Air Fuel Cell Battery System and Method of Fabricating the Same,” Sadeg M. Faris, Tsepin Tsai, Thomas J. Legbandt, Muguo Chen, and Wayne Yao, Issued Oct. 9, 2001; U.S. Pat. No. 6,190,792 issued Feb. 20, 2001 entitled “Ionically-Conductive Belt Structure for Use in a Metal-Air Fuel Cell Battery System and Method of Fabricating the Same,” Sadeg M. Faris, Tsepin Tsai, Thomas Legbandt, Wenbin Yao, and Muguo Chen; U.S. Pat. No. 6,306,534 entitled “Metal-Air Fuel Cell Battery System Employing Means for Discharging and Recharging Metal-Fuel Cards,” Sadeg M. Faris, Tsepin Tsai, Wenbin Yao, and Muguo Chen, Issued Oct. 23, 2001; U.S. Pat. No. 6,299,998 entitled “Movable Anode Fuel Cell Battery,” Tsepin Tsai and William Morris, Issued Oct. 9, 2001; U.S. Pat. No. 6,458,480 entitled “Movable Anode Fuel Cell Battery,” Tsepin Tsai, William F. Morris, Issued Oct. 1, 2002, all of which are herein incorporated by reference.

In general, the type of material having physical characteristics capable of supporting a hydroxide source may comprise an electrolyte gel. The electrolyte gel may be either applied directly on the surface of the evolution and/or reduction electrodes, or applied as a self supported membrane between the evolution and reduction electrodes. Alternatively, the gel may be supported by a substrate and incorporated between the evolution and reduction electrodes.

The electrolyte (either within any one of the variations of the separator herein, or as a liquid within the cell structure in general) generally comprises ion conducting material to allow ionic conduction between the metal anode and the cathode. The electrolyte generally comprises hydroxide-conducting materials such as KOH, NaOH, LiOH, RbOH, CsOH or a combination comprising at least one of the foregoing electrolyte media. In preferred embodiments, the hydroxide-conducting material comprises KOH. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 40% ionic conducting materials.

The gelling agent for the membrane may be any suitable gelling agent in sufficient quantity to provide the desired consistency of the material. The gelling agent may be a crosslinked polyacrylic acid (PAA), such as the Carbopol® family of crosslinked polyacrylic acids (e.g., Carbopol® 675) available from BF Goodrich Company, Charlotte, N.C., Alcosorb® G1 commercially available from Allied Colloids Limited (West Yorkshire, GB), and potassium and sodium salts of polyacrylic acid; carboxymethyl cellulose (CMC), such as those available from Aldrich Chemical Co., Inc., Milwaukee, Wis.; hydroxypropylmethyl cellulose; gelatine; polyvinyl alcohol (PVA); poly(ethylene oxide) (PEO); polybutylvinyl alcohol (PBVA); combinations comprising at least one of the foregoing gelling agents; and the like. Generally, the gelling agent concentration is from about 0.1% to about 50% preferably about 2% to about 10%.

The optional substrate may be provided in forms including, but not limited to, woven, non-woven, porous (such as microporous or nanoporous), cellular, polymer sheets, and the like, which are capable of allowing sufficient ionic transport between the reduction and evolution electrodes. In certain embodiments, the substrate is flexible, to accommodate electrochemical expansion and contraction of the cell components, and chemically inert to the cell materials. Materials for the substrate include, but are not limited to, polyolefin (e.g., Gelgard® commercially available from Daramic Inc., Burlington, Mass.), polyvinyl alcohol (PVA), cellulose (e.g., nitrocellulose, cellulose acetate, and the like), polyamide (e.g., nylon), cellophane, filter paper, and combinations comprising at least one of the foregoing materials. The substrate may also comprise additives and/or coatings such as acrylic compounds and the like to make them more wettable and permeable to the electrolyte.

In other embodiments of a hydroxide-conducting membrane as a separator, a molecular structure is provided that supports a hydroxide source, such as an aqueous electrolyte. Such membranes are desirable in that conductivity benefits of aqueous electrolytes may be achieved in a self supported solid state structure. In certain embodiments, the membrane may be fabricated from a composite of a polymeric material and an electrolyte. The molecular structure of the polymeric material supports the electrolyte. Cross-linking and/or polymeric strands serve to maintain the electrolyte.

In one example of a conductive separator, a polymeric material such as polyvinyl chloride (PVC) or poly(ethylene oxide) (PEO) is formed integrally with a hydroxide source as a thick film. In a first formulation, one mole of KOH and 0.1 mole of calcium chloride are dissolved in a mixed solution of 60 milliliters of water and 40 milliliters of tetrahydrogen furan (THF). Calcium chloride is provided as a hygroscopic agent. Thereafter, one mole of PEO is added to the mixture. In a second formulation, the same materials for the first formula are used, with the substitution of PVC for PEO. The solution is cast (or coated) as a thick film onto substrate, such as polyvinyl alcohol (PVA) type plastic material. Other substrate materials preferably having a surface tension higher than the film material may be used. As the mixed solvents evaporate from the applied coating, an ionically-conductive solid state membrane (i.e. thick film) is formed on the PVA substrate. By peeling the solid state membrane off the PVA substrate, a solid-state ionically-conductive membrane or film is formed. Using the above formulations, it is possible to form ionically-conductive films having a thickness in the range of about 0.2 to about 0.5 millimeters.

Other embodiments of conductive membranes suitable as a separator are described in greater detail in: U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. Pat. No. 6,358,651 entitled “Solid Gel Membrane Separator in Rechargeable Electrochemical Cells,” Muguo Chen, Tsepin Tsai and Lin-Feng Li, Issued Mar. 19, 2002; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties.

In certain embodiments, the polymeric material used as separator comprises a polymerization product of one or more monomers selected from the group of water soluble ethylenically unsaturated amides and acids, and optionally a water soluble or water swellable polymer. The polymerized product may be formed on a support material or substrate. The support material or substrate may be, but not limited to, a woven or nonwoven fabric, such as a polyolefin, polyvinyl alcohol, cellulose, or a polyamide, such as nylon.

The electrolyte may be added prior to polymerization of the above monomer(s), or after polymerization. For example, in one embodiment, electrolyte may be added to a solution containing the monomer(s), an optional polymerization initiator, and an optional reinforcing element prior to polymerization, and it remains embedded in the polymeric material after the polymerization. Alternatively, the polymerization may be effectuated without the electrolyte, wherein the electrolyte is subsequently included.

The water soluble ethylenically unsaturated amide and acid monomers may include methylenebisacrylamide, acrylamide, methacrylic acid, acrylic acid, 1-vinyl-2-pyrrolidinone, N-isopropylacrylamide, fumaramide, fumaric acid, N,N-dimethylacrylamide, 3,3-dimethylacrylic acid, and the sodium salt of vinylsulfonic acid, other water soluble ethylenically unsaturated amide and acid monomers, or combinations comprising at least one of the foregoing monomers.

The water soluble or water swellable polymer, which acts as a reinforcing element, may include polysulfone (anionic), poly(sodium 4-styrenesulfonate), carboxymethyl cellulose, sodium salt of poly(styrenesulfonic acid-co-maleic acid), corn starch, any other water-soluble or water-swellable polymers, or combinations comprising at least one of the foregoing water soluble or water swellable polymers. The addition of the reinforcing element enhances mechanical strength of the polymer structure.

Optionally, a crosslinking agent, such as methylenebisacrylamide, ethylenebisacrylamide, any water-soluble N,N′-alkylidene-bis(ethylenically unsaturated amide), other crosslinkers, or combinations comprising at least one of the foregoing crosslinking agents.

A polymerization initiator may also be included, such as ammonium persulfate, alkali metal persulfates and peroxides, other initiators, or combinations comprising at least one of the foregoing initiators. Further, an initiator may be used in combination with radical generating methods such as radiation, including for example, ultraviolet light, X-ray, γ-ray, and the like. However, the chemical initiators need not be added if the radiation alone is sufficiently powerful to begin the polymerization.

In one method of forming the polymeric material, the selected fabric may be soaked in the monomer solution (with or without the ionic species), the solution-coated fabric is cooled, and a polymerization initiator is optionally added. The monomer solution may be polymerized by heating, irradiating with ultraviolet light, gamma-rays, x-rays, electron beam, or a combination thereof, wherein the polymeric material is produced. When the ionic species is included in the polymerized solution, the hydroxide ion (or other ions) remains in solution after the polymerization. Further, when the polymeric material does not include the ionic species, it may be added by, for example, soaking the polymeric material in an ionic solution.

Polymerization is generally carried out at a temperature ranging from room temperature to about 130° C., but preferably at an elevated temperature ranging from about 75° to about 100° C. Optionally, the polymerization may be carried out using radiation in conjunction with heating. Alternatively, the polymerization may be performed using radiation alone without raising the temperature of the ingredients, depending on the strength of the radiation. Examples of radiation types useful in the polymerization reaction include, but are not limited to, ultraviolet light, gamma-rays, x-rays, electron beam, or a combination thereof.

To control the thickness of the membrane, the coated fabric may be placed in suitable molds prior to polymerization. Alternatively, the fabric coated with the monomer solution may be placed between suitable films such as glass and polyethylene teraphthalate (PET) film. The thickness of the film may be varied will be obvious to those of skill in the art based on its effectiveness in a particular application. In certain embodiments, for example for separating oxygen from air, the membrane or separator may have a thickness of about 0.1 mm to about 0.6 mm. Because the actual conducting media remains in aqueous solution within the polymer backbone, the conductivity of the membrane is comparable to that of liquid electrolytes, which at room temperature is significantly high. In still further embodiments of the separator, anion exchange membranes are employed. Some exemplary anion exchange membranes are based on organic polymers comprising a quaternary ammonium salt structure functionality; strong base polystyrene divinylbenzene cross-linked Type I anion exchangers; weak base polystyrene divinylbenzene cross-linked anion exhangers; strong base/weak base polystyrene divinylbenzene cross-linked Type II anion exchangers; strong base/weak base acrylic anion exchangers; strong base perfluoro aminated anion exchangers; naturally occurring anion exchangers such as certain clays; and combinations and blends comprising at least one of the foregoing materials. Another example of a suitable anion exchange membrane is described in greater detail in U.S. Pat. No. 6,183,914 entitled “Polymer-Based Hydroxide Conducting Membranes,” Wayne Yao, Tsepin Tsai, Yuen-Ming Chang and Muguo Chen, Issued Feb. 6, 2001 and incorporated by reference herein. The membrane includes an ammonium-based polymer comprising (a) an organic polymer having an alkyl quaternary ammonium salt structure; (b) a nitrogen-containing, heterocyclic ammonium salt; and (c) a source of hydroxide anion.

In yet another embodiment, mechanical strength of the resulting membrane may be increased by casting the composition on a support material or substrate, which is preferably a woven or nonwoven fabric, such as a polyolefin, polyester, polyvinyl alcohol, cellulose, or a polyamide, such as nylon.

Referring now to FIG. 10, another embodiment of a cathode structure is depicted. This cathode structure includes a rigid structure 66 generally positioned between separator 42 and the center of the cathode structure. The rigid structure 66 is generally similar to structure 20 described above for the anode structure, is used. Optionally, another separator 68 is provided adjacent to the rigid structure 66. The inclusion of the rigid structure 66 further enhances ease of refuelability and durability of the cathode structure.

The current collector for the cathode structure may be in any typical configuration. On preferred configuration is depicted in FIG. 11. As shown, a single cathode strip may be used to form a pair of cathode portions 40a and 40b. A current collector 70 may be riveted or otherwise secured centrally on the strip dividing it into the pair of cathode portions 40a and 40b. To facilitate electrical contact, a tab 72 is provided.

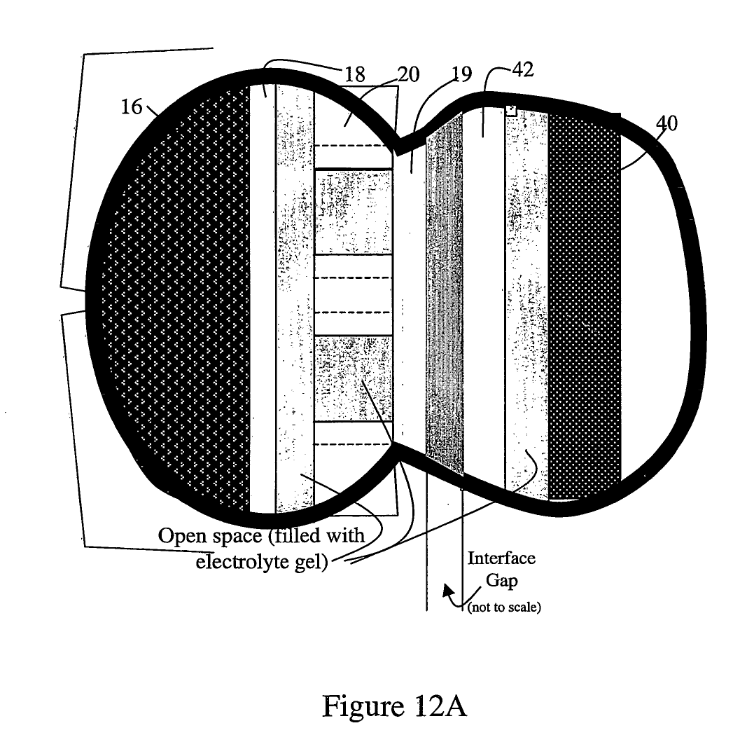

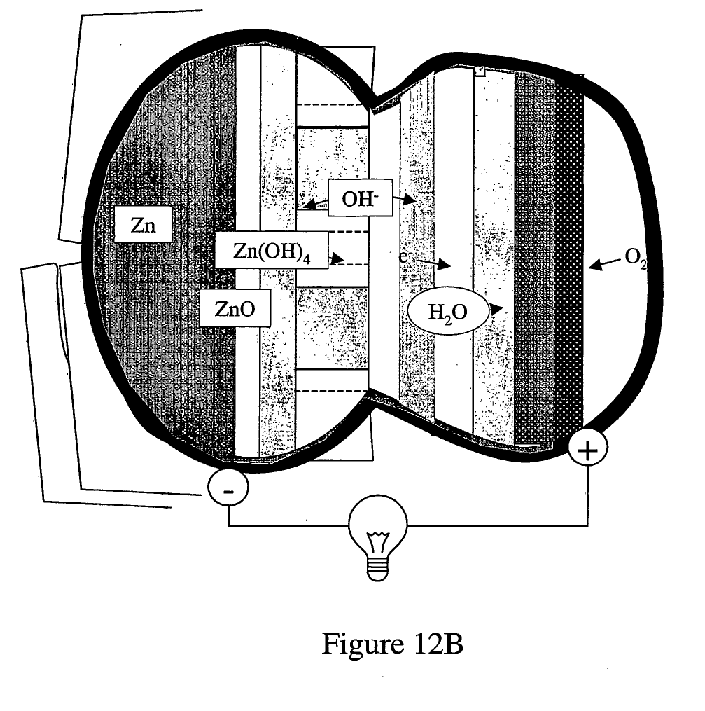

Referring now to FIGS. 12A and 12B, enlarged views of the interface within a cell including the anode and cathode are provided. Notably, in a preferred embodiment, a gap is provided between separator 19 (associated with the anode structure 12) and separator 42 (associated with the cathode structure 14). This gap is provided to allow for clearance upon refueling the anode structures.

To further facilitate refueling, a water based or electrolyte gel may be included at the interface gap between separators 19 and 42. When an electrolyte gel is used, any of the above described formulations are suitable. In certain embodiments, it is desirable to provide a lubricious non-caustic gel prior to inserting the anode structure into the cathode structure. One such gel includes water (preferably deionized water) plus any of the above first or second type gelling agents. Preferably, the gelling agents are PAA and/or Carbopol® based, to provide lubricity at the electrode interface. The gelling agents may be provided from about 0.1% to about 50% of the total solution, preferably about 2% to about 10%, more preferably about 1.5% to about 6.5% Rapidly after commencement of discharge, the ionic conducting media of the gels in the anode and/or the cathode will migrate into the interface water gel and increase ionic conductivity and decrease internal resistance.

Various benefits are derived from the metal air cell and the components described herein. The anodes structures are in a rigid cartridge form. The anode material and electrolyte gel is generally contained within the rigid structures. Further, the shape of the anode structures changes little; such that the anode structures may be easily removed from the cathode structures.

A further benefit of the metal air cell herein resides in the inherent safety of the design. The spent fuel cartridges are safe to dispose, and it is easy to recycle the used fuel. For example, the spent fuel cartridges may be processed at a recycling facility, wherein old anode material is removed and new anode material reinserted, recycling the frames and rigid structures. Alternatively, the spent fuel may be recharged in a reverse process, wherein a voltage is applied to convert the metal oxide into metal. In embodiments where a plurality of cells are assembled together, for example as described with respect to FIGS. 8A-8C, the packaging allows for easy refueling while minimizing or eliminating potential contamination of the user.

While preferred embodiments have been shown and described, various modifications and substitutions may be made thereto without departing from the spirit and scope of the invention. Accordingly, it is to be understood that the present invention has been described by way of illustrations and not limitation.

1. A metal air cell comprising:
a cathode structure comprising opposing cathode portions and a space configured for receiving an anode structure,
the anode structure including a pair of rigid structures having plural apertures for allowing ionic communication and anode material between the rigid structures; and
a separator between the anode and cathode to electrically isolate the anode and the cathode,
wherein the rigid structures of the anode structure facilitate removal of the anode structure from the cathode structure.

2. The metal air cell as in claim 1, wherein the anode structure and the cathode structure comprise electrolyte gel.

3. The metal air cell as in claim 1, wherein a gap remains between the anode structure and the cathode structure.

4. The metal air cell as in claim 3, wherein a water based gel is provided at the gap.

5. The metal air cell as in claim 1, wherein the rigid structures are non-conductive.

6. The metal air cell as in claim 5, wherein the rigid structures are in a form selected from the group consisting of plastic, plastic coated metal, ceramics, non-conductive or coated carbon composites, and combinations comprising at least one of the foregoing materials.

7. The metal air cell as in claim 1, wherein the rigid structures contain plural apertures for ionic communication between active material of the anode structure and hydroxide ions generated at the cathode structure.

8. The metal air cell as in claim 7, wherein the plural apertures are of a shape selected from the group consisting of polygons, circles, ellipses, slots, or any combination comprising at least one of the foregoing.

9. The metal air cell as in claim 1, wherein the rigid structures comprise plastic coated metal honeycomb mesh having an open area ratio of about 70% to about 90%.

10. The metal air cell as in claim 1, wherein the rigid structures comprise plastic coated metal honeycomb mesh having an open area ratio of about 78%.

11. The metal air cell as in claim 1, wherein the rigid structures counter the tendency of anode material of the anode structure to expand during electrochemical conversion.

12. The metal air cell as in claim 1, wherein the rigid structures are attached to each other.

13. The metal air cell as in claim 1, wherein the rigid structures are separate from each other.

14. The metal air cell as in claim 1, wherein electrolyte is embedded in the anode structure.

15. The metal air cell as in claim 1, wherein the anode structure includes a metal constituent selected from the group consisting of zinc, calcium, lithium, magnesium, ferrous metals, aluminum, oxides of at least one of the foregoing metals, and combinations and alloys comprising at least one of the foregoing metals.

16. The metal air cell as in claim 15, wherein the metal constituent is mixed or alloyed with constituents selected from the group consisting of bismuth, calcium, magnesium, aluminum, indium, lead, mercury, gallium, tin, cadmium, germanium, antimony, selenium, thallium, oxides of at least one of the foregoing metals, and combinations comprising at least one of the foregoing constituents.

17. The metal air cell as in claim 1, wherein the anode structure is formed of a metal constituent form selected from group consisting of powder, fibers, dust, granules, flakes, needles, and pellets.

18. The metal air cell as in claim 1, wherein the anode structure is formed of a fibrous metal constituent.

19. The metal air cell as in claim 1, wherein the anode structure includes a tube having an inlet and an outlet, wherein, during cell assembly, a gelling agent formulation in an uncured state is injected via the inlet and spreads throughout the cell via the outlet.

20. The metal air cell as in claim 1, wherein gel electrolyte is introduced to the anode structure by introducing the anode structure including rigid structure in a mold having electrolyte media therein.

21. The metal air cell as in claim 1, wherein a bimodal gelling formulation is used to promote even distribution of an electrolyte gel within the anode structure.

22. The metal air cell as in claim 21, wherein the bimodal gelling formulation comprises a first type gelling agent for providing a matrix having a relatively low viscosity with a sufficient matrix structure to allow dispersion of a second type gelling agent for providing a desired viscosity of the gelled solution, whereby the second type gelling agent is prevented from settling, or forming undesirable dense chunks or globs, during gelling.

23. The metal air cell as in claim 22, wherein the first type gelling agent is selected from the group of gelling agents consisting of cellulose fiber (long, medium, short), alpha-fiber, microcrystalline cellulose, and combinations comprising at least one of the foregoing.

24. The metal air cell as in claim 22, wherein the second type gelling agent is selected from the group of gelling agents consisting of crosslinked polyacrylic acid (PAA), potassium and sodium salts of polyacrylic acid; carboxymethyl cellulose (CMC), hydroxypropylmethyl cellulose, gelatine, polyvinyl alcohol (PVA), poly(ethylene oxide) (PEO), polybutylvinyl alcohol (PBVA), and combinations comprising at least one of the foregoing second type gelling agents.

24. The metal air cell as in claim 22, wherein the first type gelling agent concentration (in the base solution without metal) is from about 0.1% to about 50%.

25. The metal air cell as in claim 22, wherein the first type gelling agent concentration (in the base solution without metal) is from about 2% to about 10%.

26. The metal air cell as in claim 22, wherein the first type gelling agent concentration (in the base solution without metal) is from about 2.5% to about 6.5%.

27. The metal air cell as in claim 22, wherein the second type gelling agent concentration (in the base solution without metal) is from about 0.1% to about 50%.

28. The metal air cell as in claim 22, wherein the second type gelling agent concentration (in the base solution without metal) is from about 2% to about 10%.

29. The metal air cell as in claim 22, wherein the second type gelling agent concentration (in the base solution without metal) is from about 2.5% to about 4.5%.

30. The metal air cell as in claim 22, wherein the electrolyte media includes 3% microcystillane (as a first type gelling agent); and 1% CMC 250K and medium viscosity CMC as second type gelling agents.

31. The metal air cell as in claim 1, wherein the cathode structure includes air frames positioned adjacent an active cathode portion for assisting in distributed air flow across the surface of the active cathode portion.

32. A metal air cell system comprising a plurality of cells as in claim 1.

33. The metal air cell system of claim 32, wherein each cathode structure includes an associated cathode air frame that may be dedicated to one cathodes tructure or shared by adjacent cathode structures, wherein the air frames have air inlets and air outlets, wherein air inlets and air outlets of cathode air frames of adjacent cathode structures are aligned.

34. The metal air cell system of claim 32, wherein plural cells are pour casted to form an integral cell system.

35. An negative electrode structure comprising a pair of rigid structures having plural apertures for allowing ionic communication and consumable electrode material between the pair of rigid structures.

36. The negative electrode structure as in claim 35, further comprising electrolyte gel incorporated within the consumable electrode material.

37. A method of forming an anode structure comprising use of a first type gelling agent and a second type gelling agent to promote even distribution of an electrolyte gel and an active anode material within the anode structure.

38. The method of forming an anode structure as in claim 37, wherein the first type gelling agent is for providing a matrix having a relatively low viscosity with a sufficient matrix structure to allow dispersion of the second type gelling agent for providing a desired viscosity of the gelled solution, whereby the second type gelling agent is prevented from settling, or forming undesirable dense chunks or globs, during gelling.
